(19) United States
(12) Patent Application Publication
(10) Pub. No.: US 2026/0268788 A1
(43) Pub. Date: Sep. 10, 2026

(54) Research and Training Device

(71) Applicant: The United States of America, as Represented by the Secretary of the Navy, Silver Spring, MD (US)

(72) Inventors: Stephanie WARNER, Bellbrook, OH (US); Dan E. WARKANDER, Oakwood, OH (US); F. Eric ROBINSON, Dayton, OH (US)

(21) Appl. No.: 19/562,365

(22) Filed: Mar. 10, 2026

Related U.S. Application Data
(60) Provisional application No. 63/769,305, filed on Mar. 10, 2025.

(51) Int. Cl. G09B 9/00; G05D 7/06

(52) U.S. Cl. CPC G09B 9/00; G05D 7/0617

(57) ABSTRACT

The present invention is directed to a research and training device that can simulate fluctuations in gas concentrations, flow rates and pressures of breathing gas mixture delivered to the aircrew and it monitors changes in the aircrew's breathing pattern. The inventive research and training device supports simulation of real flight oxygen and ventilation conditions and permits real-time monitoring of aircrew's breathing. This invention may be used in combination with a flight simulation, hypobaric chamber, or other diagnosis methods such as MRI.

### CROSS-REFERENCE TO RELATED APPLICATIONS

This application claims priority to U.S. Provisional Application No. 63/769,305, filed on Mar. 10, 2025, the entire contents of which are hereby incorporated herein by reference.

### STATEMENT OF FEDERALLY FUNDED RESEARCH

This invention was made with government support under work order numbers H0838, and H4831 awarded by the United States Navy and H2839 awarded by Defense Health Agency. The government has certain rights in the invention.

### TECHNICAL FIELD OF THE INVENTION

The present invention relates in general to the field of flight simulation, research, and training, and more particularly, to a device and a method for breathing resistance, hypoxia, and hyperoxia ventilation simulation, training and research.

### BACKGROUND OF THE INVENTION

In recent years, aircrew have experienced physiological symptoms across multiple On-Board Oxygen Generating System (OBOGS) equipped platforms in both the US Air Force and US Navy. While many incidents have been attributed to hypoxia or malfunctioning pressure equipment, flight data have indicated that other factors such as pilot ventilation or respiratory effort may explain some of the symptomology described in these hazard reports. Periods of suboptimal Life Support System (LSS) performance can lead to reduced gas availability for aircrew, compromised mask valve operation, and brief (but notable) impediments to breathing. The effects of these breathing disruptions could potentially lead to physiological changes, subjective symptoms, or performance deficits similar to those reported. Prior research has reported inspiratory obstructions have multiple effects, including altering muscular output (Eckert et al., 2008) and duration of inspiratory effort (Romaniuk et al., 1993), which can potentially reduce the total volume of the subsequent breath (Zin et al., 1983). The need to decrease inspiratory pressure considerably before flow starts can also cause a sensation of difficulty inhaling (Yan & Bates, 1999; Chen & Yan, 1999). Higher resistive loads can decrease minute ventilation and cause the accumulation of metabolically produced carbon dioxide (CO₂) in the body (Cerretelli et al., 1969; Shykoff and Warkander, 2011; Shykoff and Warkander, 2012).

The effects of oxygen fluctuation may affect availability of oxygen in the brain. Pilots of tactical aircraft breathe hyperoxic gas in order to avoid the effects of altitude. In addition to providing protection against hypoxia, hyperoxia can improve some measures of performance such as general cognitive functioning, information processing speed and accuracy, reasoning/calculation, memory, and spatial processing (Damato et al., 2020). However, studies of the effects of hyperoxia often rely on stable oxygen delivery, whereas fluctuations in the oxygen content of breathing gas are common in OBOGS-equipped aircraft. Shykoff and DiPasquale (2018) reviewed the literature on oxygen fluctuation and found that changes in hyperoxic oxygen can affect the availability of oxygen in the brain, minute ventilation, and peripheral chemoreceptor output. Damato and colleagues (2020) report that hyperoxia leads to reduced global cerebral blood flow. Factors of flight such as changing barometric pressure, gravitational forces, or changes in work of breathing may interact with hyperoxic or fluctuating levels of oxygen in unknown ways. For example, periods of high gravitational or “G” force may further reduce cerebral blood flow and oxygen availability, compounding the effects of either exposure alone (Dean, 2020).

In a letter to the Chief of Navy Bureau of Medicine and Surgery, Commander of Naval Air Forces, identified two categories of problems requiring urgent attention: 1) breathing gas-related events, which result in hypoxia-like symptoms; and 2) cabin pressure related events, which result in symptoms consistent with decompression sickness (DCS).

Despite the impact that respiratory challenges may have on aircrew symptomology, the combined impact of aircrew breathing change and oxygen fluctuations have not been well studied. Currently there are no simulation or research devices available to support thorough study of aircrew breathing characteristics. Devices such as hypobaric chambers, the Reduced Oxygen Breathing Environment (ROBE), and the Reduced Oxygen Breathing Device (ROBD) were originally designed to study the effects of hypoxia and do not support simulations and research of other potential respiratory or physiological threats.

A traditional hypobaric chamber reduces the ambient pressure to simulate the pressure found at various altitudes, thus reducing the partial pressure of oxygen. While this method best mirrors the actual conditions of altitude, hypobaric chambers have several drawbacks that make them difficult to use for research and training purposes. Reducing barometric pressure introduces the risk of pressure-related injury (e.g., ear or sinus problems, the “bends”). Participants use a mask and regulator in the chamber, but at present there is typically no ability to alter the breathing gas through the regulator to mimic mask-on hypoxia in an aircraft. In real flight, when the breathing system malfunctions, aircrew may be exposed to the gas supply issues while wearing the breathing mask. In a hypobaric chamber, people remove their mask and breathe ambient air to experience the effects of altitude, limiting the ability to incorporate factors such as breathing resistance. The hypobaric chamber can't replicate the range of exposures that aircrew experience in the real situation. Additionally, hypobaric chambers require specialized operators and facility infrastructure and may have difficulty accommodating tasks such as a flight simulator to accurately test real-world flight scenarios.

An alternative to the hypobaric chamber is a normobaric chamber, often with see-though walls, known as the ROBE. The ROBE simulates altitude by removing oxygen from the air in the chamber to match the partial pressure found at different altitudes. This removes risks associated with changes in barometric pressure, but this process is considerably slower than other methods. Fluctuations in the aircraft LSS may occur very quickly (on the order of seconds). The ROBE can take hours to reach desired altitudes, so it's only useful to test one exposure at a time, and not suitable for simulating quick variations in LSS performance. Further, since participants in the ROBE do not breathe through a breathing mask, the inspirating gas pressure or flow cannot be manipulated to induce changes in aircrew respiration.

Mixing gases to simulate oxygen supply is nothing new and there have been commercial systems available for a long time. U.S. Pat. No. 2,414,747 (Kirschbaum, 1947) describes a system for use in aircraft to supply occupants with the proper amount of oxygen required for normal functioning at various altitudes. The primary goal is to automatically control the composition of the gas mixture supplied to the user. This ensures that the oxygen partial pressure in the lungs remains substantially constant, regardless of changes in altitude. The apparatus includes means to automatically control the pressure within the supply mask to maintain the desired pressure in the user's lungs. Numerous improvements have been made to this system, including adjusting the level of inspired oxygen to instead provide a predetermined level of arterial oxygen partial pressure in the body.

U.S. Pat. No. 4,326,513 to Shultz describes a patient data-controlled respiration system utilizing sensed levels of oxygen in the patient's blood to control a respirator supplying breathing air having a selected concentration of oxygen therein to the patient.

To maintain a suitable level of inspired oxygen to flight crew in aircraft at altitude, 100% oxygen can be blended with cabin air. Such diluter regulators have been in common use for a long time (e.g. see page 2-31 and 2-32 in the Flight Surgeon Guide, Department of the Air Force, AFP 161-18, 1968).

U.S. Pat. No. 6,871,645 to Richard Wartman et al. describes the ROBD device developed by the Navy, that blends a desired mix of air and nitrogen to reduce the oxygen level in inhaled gas for the purpose of simulating the partial pressure of oxygen at various altitudes (delivering an oxygen concentration of 0-21% for altitude & 100% for emergencies/recovery). ROBD delivers gas through a breathing mask, allowing the study of mask-on hypoxia and relatively easy incorporation with a flight simulator. However, ROBD has several limitations that prevent it from fully replicating the behavior of an aircraft LSS. First, ROBD does not blend gas mixtures with oxygen (O₂) levels between 21%-99%, which is needed to fully mimic background conditions of an aircraft during flight. In the real-world, the O₂ concentration varies with the intent to keep the aircrew at least at a normal partial pressure of O₂. The Navy typically provides 94% O₂ at all altitudes, while the Air Force follows a prescribed oxygen schedule that varies based on aircraft and cabin altitude (e.g., 55%-100% O₂).

Another shortcoming of the ROBD is it utilizes a constant flow rate rather than a pressure-demand system characteristic of tactical aircraft (i.e., gas from the ROBD is always flowing to the mask, whereas aircraft only deliver gas when the aircrew inhale). Therefore, it does not allow studies of air flow's impact on aircrew breathing. Furthermore, the ROBD delivers gas with less pressure than some aircraft LSS (e.g., CRU-103 regulator of T-45 requires 25 PSI inlet pressure for optimal functioning) and does not allow control of the output pressure.

There is no known system that allows adjustments of gas concentrations, flow, or delivery pressures due to feedback from other external sensors (e.g., flow rate sensor located between breathing regulator and the mask, altitude, throttle setting). Current systems also do not support real-time recording of the breather's reaction to changes in gas delivery (e.g., gas concentrations, flows or pressures).

Existing systems are not suitable for complete aircrew respiratory research or training because they cannot simulate in-aircraft breathing conditions, do not allow for full control of oxygen concentration or gas delivery pressure to a breathing regulator, and they lack detailed monitoring of the user.

For these reasons, the future of aeromedical research on aircrew respiration requires a more capable simulation system. Current hypoxia induction systems need to be improved upon to permit precise control and measurement of breathing gas partial pressure, total pressure, and to better address the physiological incidents currently experienced by tactical aircrew. There is a critical need for a system and a method that will allow measurement and manipulation of gas delivery to aircrew, while being able to rapidly deliver any desired concentration of oxygen at a desired supply pressure and means to monitor the effects on the aircrew. The inventive system and method incorporates some of the best features of current devices (e.g., low operating cost, low logistic footprint, flight simulator compatibility, improved safety), while also incorporating new capabilities to study the effects of breathing resistance, hypoxia, and hyperoxia under conditions that more closely resemble the actual flight environment. Such conditions include providing oxygen concentrations, pressure, and maximum available flow of gas to match what an existing LSS would deliver at various altitudes, throttle settings and engine speeds and under different failure conditions. This inventive research and training system facilitates examination of new questions relevant to factors that affect breathing patterns, hypoxia and hyperoxia, such as the impact of pre-breathing or different gas mixtures on physiological symptoms, performance, and recovery of aircrew. The inventive research and training system can also be incorporated with an altitude chamber or centrifuge to enable high-fidelity representation of the pilot/aircraft LSS environment. In short, the inventive research and training system can generate fast and slow changes in oxygen concentration, supply pressure, and maximum available flow to a breathing regulator while monitoring the effects on the aircrew/pilot.

### BRIEF DESCRIPTION OF DRAWINGS

The invention will be described with reference to the drawings, in which like elements have been denoted throughout by like reference numerals. The representation in each of the figures is diagrammatic and no attempt is made to indicate actual scales or precise ratios. Proportional relationships are shown as approximations. Arrows indicate the direction of flow of gas or information.

FIG. 1 is a schematic block diagram of the system set up to deliver gases with desired concentrations at a desired flow rate.

FIG. 2 is a schematic block diagram of the system set up to deliver breathing gas with desired concentrations at a flow rate and pressure based on the breathing profile for a simulation.

FIG. 3 is a schematic block diagram of the system set up that delivers gas with the desired concentrations and desired pressure, where a back pressure controller is used.

FIG. 4 shows CRU-103 supply pressure and proportion of O₂ in the breathing gas for the Control (top) and testing condition where a physiological event (PE) may have occurred (bottom) conditions. The X axis is scaled in five-minute intervals.

FIG. 5 is an example plot with several outcome measures illustrated. Notes: 1) flow has been negated and scaled for visibility, 2) outcome measures for post regulator pressure were exact analogues to mask pressure outcome measures, 3) indicated outliers would be excluded according to M+3*SD, 4) some signals in the legend are not visible in the plot due to highlighting of signal features.

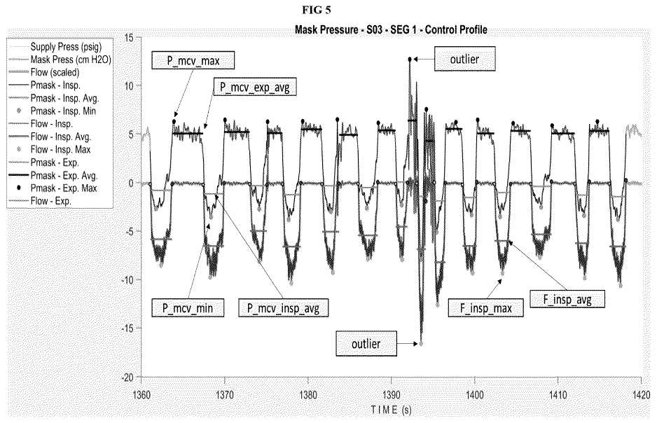

FIG. 6 is FIG. 2a in attached MIL STD 3050A.

FIG. 7 shows an example of a performance graph of a GGU 7A OBOGS. This graph has been extracted from a data sheet provided by the manufacturer (Eaton, Orchard Park, NY).

### SUMMARY OF THE INVENTION

An objective of this invention is an improved research and training device with increased flow capabilities (peak flows greater than 300 Liters Per Minute (LPM)) and is capable of providing variable delivery gas pressures to an aircrew.

Another objective of this invention is a research and training device that is capable of providing oxygen to an aircrew at full oxygen concentration range (0-100%).

Yet another objective of this invention is a research and training device that supports adjustments of gas concentrations/contents, flow rate and delivery pressures based on feedback from external sensors (e.g. flow rate, altitude, throttle setting) to mimic actual aircraft LSS during a flight.

The present invention also describes a flight training and simulation system that combines the inventive research and training device with a flight simulator or attitude chamber.

The present invention also describes a method to monitor and record aircrew breathing profile in simulated flight scenarios using inventive research and training devices.

### DETAILED DESCRIPTION OF THE INVENTION

The inventive research and training device addresses the shortcomings of the prior art, it provides the user the ability to change the concentrations or contents of gases being breathed by the aircraft crew, and the pressure or flow rate at which the gases are delivered to the aircrew via aircraft breathing system. The present research and training device (also called Hypoxia-Ventilation Research Device or HVRD) is capable of closely mimicking actual conditions of the aircraft LSS during actual flight, including the fluctuations in gas concentration, contents, and delivery flow rate and pressure. It also allows the aircrew's breathing profiles to be measured and monitored, recorded in real-time as these fluctuations occur.

One application of the inventive device is to provide breathing simulations representing different experimental or training scenarios and allow monitoring/recording of the aircrew's breathing profiles.

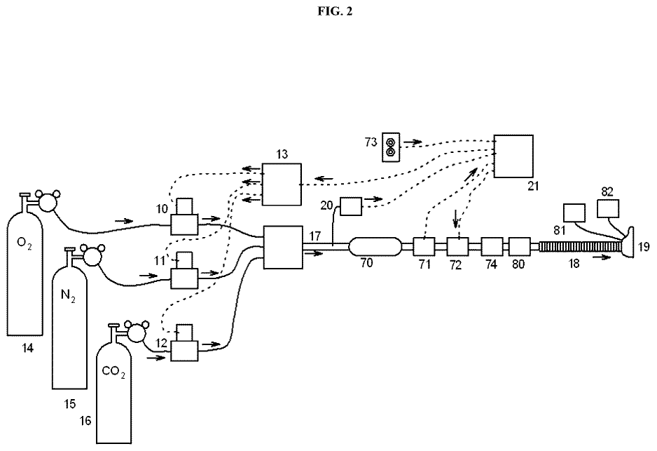

For instance, hypoxia and hyperoxia simulations can be performed by generating rapid changes in oxygen concentrations in an aircrew's inspired gas while the aircrew's breathing profile is monitored and recorded. The present invention is also capable of simulating hypercapnia by adding CO₂ to an aircrew's inspired gas. Another application is to simulate an OBOGS working at the limit of its flow and pressure delivery capability and study its impact on the aircrew. The inventive research and training device is capable of simulating the fluctuations in gas concentrations, the pressure or flow rate of gases delivered to a breathing regulator 74 (FIG. 2) in response to known performance of an aircraft compressor (e.g., the compressor part of a jet engine) or external parameters such as aircraft altitude, engine speed or throttle setting.

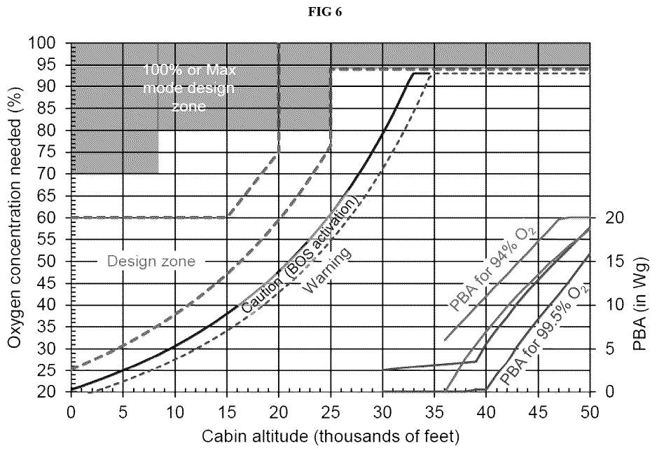

An OBOGS creates breathing gas for the aircrew by feeding engine compressor “bleed air” through molecular sieve beds to remove nitrogen. However, “bleed air” from the engine compressor need to be provided at sufficient flow rate and pressure to the OBOGS to generate the desired O₂ concentration in the breathing gas to aircrews. This oxygen concentration demand of the aircrew is based on aircraft altitude. See FIG. 6.

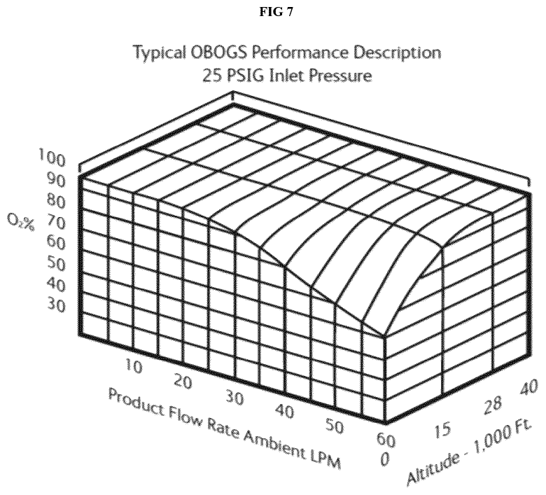

If the OBOGS receives “bleed air” at insufficient gas flow rate or pressure, it will not generate O₂ concentration control to meet those demands. The range of O₂ concentrations produced by an OBOGS varies from 21 to 94%. FIG. 7 shows an example of a performance graph of a GGU 7A OBOGS. This graph has been extracted from a data sheet provided by the manufacturer (Eaton, Orchard Park, NY). The graph in the lower left shows that for high flows and low altitudes, the O₂ concentration drops from 94% to around 60%. The impact of throttle speed on O₂ concentrations, pressure and flow rate of gas delivered to a breathing regulator can be demonstrated in two flight scenarios. In the first scenario, an aircraft is idling waiting for its turn to take off. To minimize fuel consumption, the engine will be set to run at the lowest possible speed. The engine's compressor will then also produce the lowest pressure and the lowest available flow. At low altitudes, the OBOGS will not perform at peak efficiency. With low air pressure from the compressor, the OBOGS will produce oxygen at low flow rate, which will result in the delivery of low O₂ concentration breathing gas to the aircrew and might fail to meet the demands of aircrew at that altitude. In a second flight scenario, an aircraft is descending slowly. The engine will be operated at its lowest speed, and the compressor might not deliver enough breathing gas to the aircrew to breathe and the O₂ concentration in the breathing gas may also be low. With knowledge of how an aircraft will deliver O₂ concentrations and gas flow to aircrew, such flight scenarios can be simulated by inventive research and training device (or HVRD). For instance, recorded flight profile or readings from a flight simulator can provide information on current altitude, throttle setting (engine speed) to the HVRD. The HVRD can then mimic gas concentrations, pressure and flow rate of breathing gas that an aircraft would deliver to an aircrew under such conditions and record the breathing responses from the aircrew.

The present invention allows the user to simulate the different flight scenarios on the ground instead of in the air, therefore provide flight-like research and training conditions in a safer and less expensive environment. The present research and training device can recreate the actions of an aircraft LSS based on a pre-recorded flight profile, allowing real-time monitoring of aircrew breathing responses and examination of the factors impacting aircrew's breathing and physiological response. In all flight scenarios, the effects of the changes in breathing system such as breathing gas flow rate and pressures are measured by pressure sensors, a flow meter and by gas analyzers. The breathing profiles and physiological responses of the aircrew (e.g., changes in exhaled CO₂, mask pressures, respiratory rate, tidal volume, respiratory duty cycle, minute ventilation) are monitored and recorded in real-time and examined later.

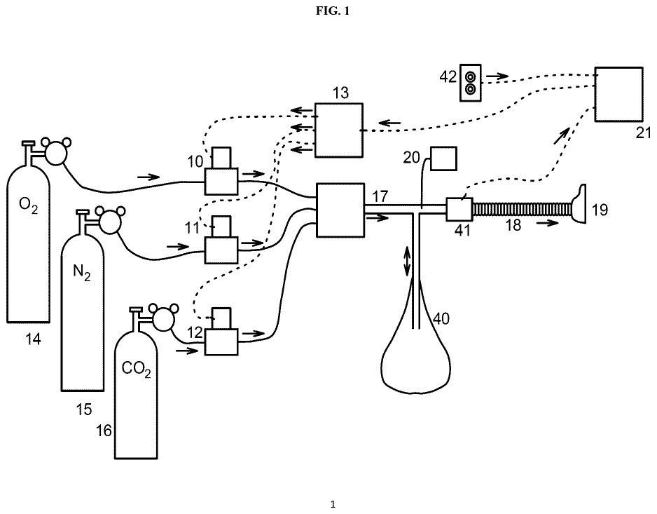

As illustrated in FIG. 1-3, a research and training device of the present invention (or HVRD), comprising (a) two or more gas sources 14, 15, 16 (FIG. 1-3), which are in fluid communication with a mixing chamber 17, wherein flow rates at which each said gas is delivered from each said gas source to the mixing chamber 17 is controlled by the respective flow controller 10, 11, 12; (b) said mixing chamber 17 is in fluid communication with gas sources 14, 15, 16 and an inspired gas reservoir 40 (e.g., a weather balloon or Mylar bag) (FIG. 1) or 70 (e.g., a pressure vessel) (FIG. 2), wherein said gases from each said gas sources 14, 15, 16 are mixed in the mixing chamber 17 and delivered to said inspired gas reservoir 40 or 70; (c) a gas analyzer 20 analyzes the composition of the mixed gas, a flow meter 41, a pressure sensor 71 are placed between said inspired gas reservoir 40 or 70 and a breathing hose 18 connected to a breathing mask 19, before delivered to aircrew via said breathing hose 18 and breathing mask 19 and the flow rate is measured and pressure in the flight mask 19 is measured by pressure sensor 81 and the fast responding gas analyzer 82 measures O₂ and CO₂ levels on a breath-by-breath basis; and (d) a main controller 21 which receives measurements from the gas analyzer 20, the flow meter 41, the pressure sensor 71, and controls the function of said individual flow controller 10, 11, 12 based on their measurements and the oxygen demand of the aircrew, which could depend on the altitude of the aircraft, the throttle speed and pressure of the aircraft.

At least one of the gas sources must be an oxygen source. Other gas sources may include a nitrogen source, a carbon dioxide source, an argon gas source or compressed air. The main controller 21 may directly control the functions of individual flow controller 10, 11, 12 or via a breakout box 13. The main controller 21 may be a microcontroller or a stand-alone computational device such as a computer or a mobile phone, which is equipped with software or control programs. The main controller 21 communicates with flow meter 41, pressure sensor 71, monitors, records real time pressure and flow rate measurements and controls the functions of flow controllers 10, 11, 12, pressure controller 72 and/or back pressure controller 90 based on a predetermined profile for the simulation or manual entries. Those inputs may be informed by the user's understanding of the function of the aircraft/regulator and measurements from the flow meter 41 and pressure sensor 71. Individual flow controllers can be any controller capable of gas flows of 50-300 LPM, depending on the intended research and training design. An example of an individual flow controller is Alicat Scientific Inc, Tucson, AZ USA model number MCR-100SLPM-D/5M. An example of pressure controllers is Alicat Scientific Inc PCR series. A breakout box 13 is a connectivity tool that splits a single, complex multi-pin cable into individual, accessible connection points (banana jacks or terminals) to facilitate easy testing, diagnostics, and monitoring. In the prototype, an Alicat BB9 breakout box is used. The flow meter suitable for use in this invention is capable of measuring and recording up to maximum expected peak flow rate of 350 LPM. Pressure sensor 17 is capable of measuring pressure between 0 and 100 pounds per square inch gauge (PSIG).

FIG. 1 illustrates an embodiment of the inventive research and training device delivering breathing gas comprising of three gases (e.g., oxygen, nitrogen, and carbon dioxide) to the aircrew at a desired concentration and flow rate. Individual flow controllers 10, 11 and 12 add oxygen, nitrogen, and carbon dioxide to the mixing chamber 17 at the desirable flow rates determined by a main controller 21. Gases are delivered from gas sources 14, 15 and 16, respectively. The gases are mixed in mixing chamber 17 and are delivered into inspired gas reservoir (i.e., air bag 40). The mixed breathing gas is delivered from the inspired gas reservoir 40 to the aircrew through a flowmeter 41, breathing hose 18 and breathing mask 19. The concentration of the breathing gas is verified by a gas analyzer 20 located before breathing hose 18. Main controller 21 receives measurements from the flow meter 41 and gas analyzer 20 and adjusts the flow setpoints for controllers 10, 11 and 12 based on oxygen demand of the aircrew at selected altitude or a pre-determined profile. In yet another embodiment, a manual control box 42 can optionally be used to manually control the gas concentration and total flow rate of the breathing gas delivered to the aircrew. A person would breathe from mask 19. The flow to bag 40 can be adjusted such that the bag doesn't empty. Inspiratory flow is measured by flow sensor 41.

FIG. 2 illustrates an embodiment of the inventive research and training device delivering breathing gas comprising of three gases (e.g., oxygen, nitrogen, and carbon dioxide) to the aircrew at a desired concentration and pressure. It functions in a similar way to the embodiment illustrated in (FIG. 1) except that instead of a breathing bag 40 the gas is delivered to a pressure vessel 70. Pressure sensor 71 is located between pressure vessel 70 and pressure controller 72, which monitors the pressure of breathing gas being delivered out of the pressure vessel and feeds its measurements to the Main controller 21. Main controller 21 adjusts the flow controllers 10, 11, 12 to obtain the desirable gas contents and concentrations in breathing gas passed to the pressure vessel 70 using standard control techniques based on the feedback measurements from gas analyzer 20. Main controller adjusts the pressure of breathing gas feeding into the breathing regulator 74 via the pressure controller 72. This pressure controller 72 maintains fine pressure control at its outlet at a pressure set by main controller 21 based on measurements from pressure sensor 71. The breathing regulator of the aircraft 74 that delivers the breathing gas to the aircrew through breathing hose 18 and mask 19. Control box 73 can optionally be used to manually control the gases content/concentration and pressure of the breathing gas delivered to the aircraft breathing regulator 74. A person would breathe from mask 19, Inspiratory flow is measured by flow sensor 80. Pressure in mask 19 is measured by pressure sensor 81. Variations in O₂ and CO₂ in mask 19 are measured by a fast responding gas analyzer 82 on a breath-by-breath basis.

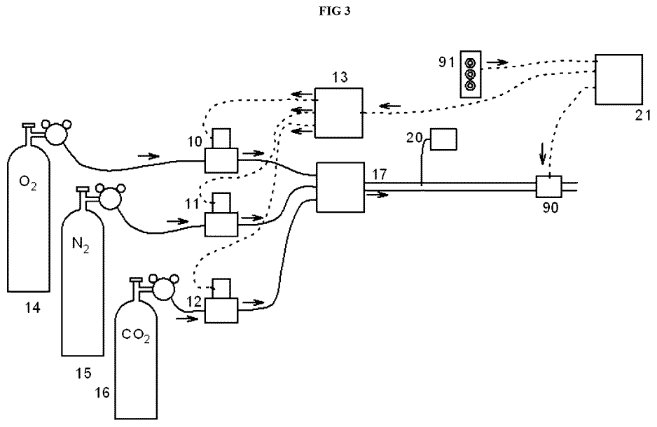

FIG. 3 illustrates an embodiment of the inventive research and training device delivering breathing gas at a desired gas concentration/content on demand. It functions in a similar way to embodiment illustrated FIG. 2 except that instead of pressure vessel 70 and pressure sensor 71, a back pressure controller 90 is used to set the pressure in the supply line upstream of itself. The desired combination of breathing gas of desirable gas concentration is verified by gas analyzer 20. The Main controller adjusts the concentration of gases using via individual controllers 10,11,12. The back pressure controller 90 ensures breathing gas flows in only one direction to aircrew, preventing expired gas from reversing into the pressure vessel 70. Control box 91 can be used to manually set the gas concentrations, flow and pressure.

Even though these illustrations use three gases (O₂, N₂ and CO₂), it is obvious that the number and type of gases can be adjusted to serve a desired need. This allows us to examine/simulate a variety of potential exposures, in addition to hypoxia, that may arise in an OBOGS-equipped aircraft. Using Argon gas as the third gas would allow us to simulate the normal operation of an OBOGS and using CO₂ allows us to induce hypercapnia or attempt to restore normocapnia for hypocapnic person.

In operation, the main controller 21 can be set to:
a. follow the manual settings of the control box (42, 73 or 91),
b. be set to maintain constant values or follow pre-programmed profiles manually generated or from a real flight, or
c. be set depending on values from external sensors (e.g, flow meter, pressure sensor, flight simulator parameters such as throttle speed or altitude).

Common components of the research and training device of the present invention as described in FIGS. 1-3 are the breathing hose 18 and breathing mask 19. It is possible to adjust breathing resistances to make it more or less hard for aircrew to breathe via breathing regulator. A flow meter may be inserted into the breathing hose 18. Pressure sensor, and gas analyzers maybe connected to the breathing mask taking real-time measurements of breathing sample from the aircrew. A breathing profile of the aircrew can be constructed from these measurements, including minute ventilation, peak and mean inspiratory flow, tidal volume, breathing frequency, respiratory duty cycle, peak and mean inspiratory and expiratory mask pressures, and end-tidal O₂ and CO₂ levels. The effects of breathing gas pressure, flow rate or breathing impediments can be evaluated. Thus, it is possible to explore the impacts fluctuations in gas concentrations, flow rate, and pressures have on aircrew breathing.

The present research and training device (HVRD) may be used to train aircrew to recognize signs of hypoxia, or hyperoxia or hypercapnia, and may be paired with a flight simulator to enhance perceived realism. The combination will also allow examination of the Physiological Effect on aircrew breathing under different flight scenarios such as repeated activations of an automatic Backup Oxygen System (ABOS) in an aircraft. The inventive research and training device can also be used with another diagnostic device, such as magnetic resonance imaging (MRI) to assess neurophysiological effects of different flight conditions, such as non-standard oxygen supply's impact on the central nervous system, which cannot be assessed in actual flight conditions.

To suit the needs of a test, the inventive research and training device can be operated in one or more of the following three modes:
1: to control gas concentrations of a breathing gas mixture that is delivered at a desired flow.
2. to control gas concentrations of a breath gas mixture that is delivered at a desired pressure,
3: to control gas concentrations and pressure and flow rate of a gas mixture that is delivered as per certain flight parameters (e.g., aircraft altitude, cabin pressure, different breathing regulators, engine or throttle setting)

### Example 1: Evaluating Fluctuations in Breathing Gas Delivery to Flight Breathing Profile

A surge of reported physiological symptoms among pilots in the Navy's fleet of T-45 jets had been observed. Among the primary suspected causes for such physiological events (PEs) was fluctuating breathing gas delivery pressure and O₂ concentration due to inconsistent performance of the aircraft LSS. The inventive research and training device was used to recreate the aircraft-recorded variable delivery pressure and content of the breathing gas delivered to aircrew who reported a real-world PE while participants performed a cognitive task and mild exercise on a cycle ergometer. These data were compared to the same participants' data while breathing gas supplied at a steady delivery pressure and composition. Results were used to determine if fluctuations in inspired gas delivery contributed to the disruption of aircrew respiration and physiology.

Changes in work of breathing and oxygen concentration of delivery gas may contribute to physiological symptoms in the aircraft. This study sought to replicate a PE in the laboratory by exposing participants to the same levels of oxygen and pressure fluctuations observed in the aircraft during the incident. This PE was particularly interesting because there were no noted mechanical or system failures, the oxygen content was sufficient to avoid hypoxia, and contamination was ruled out as a contributing factor. In addition, the front seat pilot reported symptoms whereas the rear seat pilot did not, despite a shared exposure. This PE therefore offered an opportunity to examine the effects of gas delivery pressure/oxygen fluctuations in isolation from other potential contributing factors and raised important questions about individual differences in PE risk.

### Design

The study replicated the oxygen content and gas delivery pressure recorded from a T-45 during a PE to examine the possible impact of multiple fluctuations in breathing pressure and O₂ concentration. The study entailed two conditions; (1) a control condition with participants breathing up to 65% O₂ at steady concentrations and delivery pressure throughout the length of the flight profile and (2) a PE condition with the gas delivery pressure fluctuations and O₂ concentrations associated with this PE (described in more detail below).

Fifteen participants (12 male) volunteered. All participants were active-duty U.S. Navy flight surgeons who were attending a post-graduate Master's in Public Health program as their tour of duty in Pensacola, Florida. All participants were medically cleared to fly. Participant ages ranged from 31 to 49 (M=38.3±6.4).

### Apparatus

Breathing gas was delivered via the inventive device (also called Hypoxia-Ventilation Research Device or HVRD). Breathing gas was delivered through a CRU-103 regulator serviced according to the prescribed 90-day inspection cycle. From the CRU-103, the breathing gas passed through a pneumotachometer (Series 4830, flow range 0 to ±400 L/min, Hans Rudolph) then through a standard aviation breathing hose to an MBU 23/P flight mask (GENTEX), the mask model that is most common in the T-45. All mask valves were in new condition at the beginning of the study. Ports added to the mask allowed measurement of mask pressure and end-tidal CO₂.

Pressures were recorded at various points of the gas delivery system: at the supply to the CRU-103 (plenum output), at the output from the CRU-103, and from the mask. All pressures, including those generated by the flow, were measured using pressure-compensated, amplified, ratiometric pressure transducers (SSC series, HONEYWELL SIT, Fort Mill SC). CO₂ in the breathing mask was captured via a sampling tube inserted into the mask cavity to a location between the nose and mouth. The sampled gas was drawn at 500 mL/min into a fast-response NDIR analyzer (GA-200, iWorx, Dover NH). No electronic filtering was used. A custom application written in Lab VIEW 2015 (National Instruments, Austin, TX) sampled data from the breathing apparatus and the mask at 100 Hz. Data were displayed in real-time and stored in a text file.

Participants pedaled on a cycle ergometer (Monark 828E) in order to stimulate elevated respiratory demand similar to that recorded in flight (Gordge, 1993).

### Measurements

The participants' physiological, respiratory, cognitive, and subjective variables were measured.

### a) Physiological:

Heart rate were captured using a Zephyr harness. Transcutaneous CO₂ and O₂ were measured using a Radiometer TCM CombiM with the sensor placed below the clavicle on the participant's left side. End-tidal CO₂ was measured in the flight mask as described above.

### b) Respiratory:

Respiratory variables were derived from measurements captured by pressure, flow, and gas sensors associated with the operation of the HVRD. Table 1 lists the variables used in our analysis, as well as how they were calculated.

TABLE 1
Respiratory variables and how they were derived.

| Variable | Means of calculation |
|---|---|
| Flow during inspiration | Measured directly in the breathing hose |
| Respiratory duty cycle | Derived based on flow data |
| Minute ventilation | Derived based on flow and respiratory |
| | duty cycle |
| Mask pressures | Measured directly in the mask |
| Regulator pressures | Measured directly before/after the regulator |
| Work of breathing | Derived based on pressure/flow measures |
| | over time |

### c) Cognitive:

Participants completed a computerized psychomotor vigilance task continuously throughout testing. The task was displayed a crosshair background, along with a cursor that moved randomly around the screen. The participants' task was to keep the cursor as close to the center of the crosshair as possible using a joystick. Error was measured as the distance of the cursor from the center of the crosshair.

### d) Subjective:

Participants reported their perceived symptoms and experience of the breathing profile using a series of response buttons located on the joystick used in the cognitive task. Participants pressed a green button any time they perceived a change in the delivery of the breathing gas (i.e., noticed that it became harder or easier to breathe). They pressed a yellow button if they noticed symptoms developing, and a red button if symptoms became severe enough that they would declare an in-flight emergency or pull their car to the side of the road.

Participants rated their perceived overall exertion using the Borg RPE scale (Borg, 1970). This scale ranges from 6 (no exertion at all) to 20 (maximal exertion) and is designed to correlate with heart rate. Participants reported their workload every minute throughout the exposure.

Participants completed a symptoms questionnaire upon completion of the exposure. The questionnaire asked participants to identify and rate the severity of any experienced symptoms, based on the symptoms listed in an assessment form used by medical personnel after real-world PE reports.

### Gas Delivery Profile

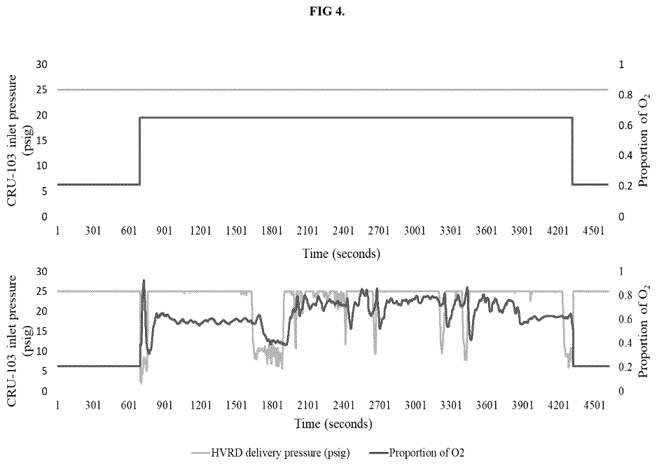

The exact oxygen content and delivery pressure at the CRU-103 for the control and PE conditions are shown in FIG. 4. For both conditions, participants pedaled on the bicycle for a brief warmup phase maintaining a speed of 50 rotations per minute (rpm) with the bicycle resistance set at 0.5 kp. After the warmup, participants donned the flight mask and began to breathe gas supplied by the HVRD; HR, O₂, and CO₂ were recorded for five minutes with the bicycle resistance set at 0.75 kp to allow physiological readings to stabilize. An additional five-minute baseline phase continued to record HR, O₂, and CO₂ pedaling the bicycle with the resistance set at 0.75 kp. From this point on, participants were asked to rate their level of workload every minute using the Borg RPE Scale. For the next 61 minutes, bicycle resistance was set at 1.0 kp while physiological measurements continued. Participants were periodically reminded about the green/yellow/red subjective response buttons throughout the exposure phase. Participants continued to pedal at 50 rpm while recording the aforementioned physiological parameters every minute along with subjective workload. After completing the 61-minute exposure, participants began a five-minute recovery phase with the bicycle resistance reduced to 0.5 kp. At the end of the recovery phase, participants removed the flight mask and monitoring equipment and stopped performing the tracking task. Participants completed a post-exposure subjective symptoms survey before departing.

### Results

Table 2 shows an annotated version of one of the plots generated in the MATLAB data processing script, illustrates pressure and flow related outcome measures

TABLE 2
Description of each processed variable.

| Variable | Units | Explanation |
|---|---|---|
| F_insp_max_avg | L/min | Peak flow during inspiration, |
| | | averaged across breaths |
| F_insp_avg_avg | L/min | Average flow during inspiration for |
| | | a single breath, averaged across |
| | | breaths |
| P_mcv_max_avg | cm H₂O | Peak mask pressure, averaged across |
| | | breaths |
| P_mcv_exp_avg_avg | cm H₂O | Average mask pressure during expira- |
| | | tion for a single breath, averaged |
| | | across breaths |
| P_mcv_min_avg | cm H₂O | Minimum mask pressure, averaged |
| | | across breaths |
| P_mcv_insp_avg_avg | cm H₂O | Average mask pressure during inspi- |
| | | ration for a single breath, averaged |
| | | across breaths |
| P_prg_max_avg | cm H₂O | Maximum post-regulator pressure for |
| | | a single breath, averaged across |
| | | breaths |
| P_prg_exp_avg_avg | cm H₂O | Average post-regulator pressure |
| | | during expiration for a single |
| | | breath, averaged across breaths |
| P_prg_min_avg | cm H₂O | Minimum post-regulator pressure for |
| | | a single breath, averaged across |
| | | breaths |
| P_prg_insp_avg_avg | cm H₂O | Average post-regulator pressure |
| | | during inspiration for a single |
| | | breath, averaged across breaths |
| WOB_insp_avg | J/L | Inspiratory work of breathing for |
| | | a single breath, averaged across |
| | | breaths |
| V_insp_avg | L | Inspired volume for a single breath, |
| | | averaged across breaths |
| VI_avg | L/min | Average of minute volume |
| RDcyc_avg | ratio | Average respiratory duty cycle |
| BR_avg | l/min | Average breath rate |
| CO2_max_avg | % | Peak CO₂, averaged across breaths |
| | | (approx. etCO₂) |

Note: For variable names including two summary statistics, e.g., F_insp_max_avg, the first statistic pertains to individual breaths, and the second pertains to all breaths across a segment of data. If there is a single summary statistic in the name, e.g., V_insp_avg, the summary statistic pertains to the entire segment. MCV=mask cavity.

Other breathing variables may be calculated from measured profiles. For examine, inspired work of breathing was calculated for each breath according to ISO 16900-12 (Respiratory protective devices—Methods of test and test equipment—Part 12: Determination of volume-averaged work of breathing and peak respiratory pressures. International Standards Organisation, Geneva, Switzerland).

Unit conversions were performed such that the final units for WOB_insp were J/L. Reimann sums (discrete integrations) were performed using the ‘trapz’ function in MATLAB. FIG. 4 illustrates the curves and quantities involved in the WOB_insp calculations.

In addition to the outcome measures described above, summary measures were also calculated for the experimentally manipulated variables, i.e., oxygen and supply pressure. This was done to ensure that the HVRD successfully replicated the planned experimental pressure/oxygen profiles.

### Example 2: Evaluating the Physiological Effect of Automatic Backup Oxygen System (ABOS) in an Aircraft

The inventive research and training device was used to examine whether repeated activations of an automated backup oxygen system (ABOS) in an aircraft may have unintended physiological effects. The HVRD was used to replicate the expected changes to gas delivery pressure and oxygen concentration associated with degraded LSS performance, ABOS activation, and return to breathing from the LSS. This study was performed in a hypobaric chamber.

### Example 3: Monitoring the Neurophysiological Effects and Hemodynamic Response to Hypoxia Using HRVD in an MRI Environment

The inventive research and training device is used to investigate the neurophysiological effects and hemodynamic response to hypoxia using functional magnetic resonance imaging (fMRI). fMRI is a neuroimaging technique that measures brain activity by detecting changes in oxyhemoglobin concentration. Through a specific sequence of radiofrequency pulses, the scanner can measure signals which fluctuate due to the variable magnetic properties between oxy- and deoxyhemoglobin. By modeling these changes over time, fMRI can create a map of brain activity showing which areas are most active during specific tasks. Brain activity measures from fMRI are more sensitive than traditional behavioral measurements and may detect novel deficits not observed in other neuroimaging techniques such as EEG. fMRI allows researchers to visualize localized neural responses which may be altered from environmental stressors associated with flight or effects from underperforming or malfunctioning equipment.

Hypoxia is a condition where the body does not have enough oxygen to function normally and can occur when breathing oxygen concentrations that are lower than normal (21% oxygen at sea level). Alternatively, hyperoxia describes the state in which there is an excess supply of oxygen in the body and can occur when breathing oxygen concentrations that are above normal breathing air. The inventive research and training device was used with an MRI to examine the changes in blood oxygen level dependent (BOLD) activity and blood flow velocity to and volume in the brain before, during, and after a hypoxic (low oxygen) episode. Each MRI lasted approximately 65 minutes and was used to measure participant brain activity. Each session consisted of an approximate 10-minute baseline (either normal ambient oxygen or hyperoxia condition (100% Oxygen)), a 15-minute hypoxic condition (~9.7% O₂, 20,000 foot equivalent), and an up to 40-minute recovery period in which either 100% oxygen or 21% oxygen was given to the participant. During experimentation, basic cognitive tasks were performed in the MRI to assess changes in physiological function for the duration of the session. Additionally, the physiological response to the administration of either 100% or 21% oxygen concentrations during the recovery period was indexed for evidence of negative effects on performance. The current emergency procedure standards for in-flight use in tactical aircraft specify the use of 100% oxygen. The results of these efforts will provide information to potentially update emergency procedures and to establish a timeframe for returning to duty following a hypoxic event by examining changes in cerebral perfusion, brain metabolite concentrations, and brain activity via MRI. The inventive research and training device was used to mix all necessary concentrations and deliver them to the participant at the required gas pressures and concentrations.

### Prophetic Example 4: Regulator Modeling for Hypoxia Ventilation Research Device (HVRD)

It is beneficial to utilize aircraft LSS components for high fidelity human subject research and physiological monitoring device development and validation. However, access to actual aircraft LSS can be costly, limited, and time sensitive. To help mitigate the issues associated with access to actual aircraft LSS components, specifically breathing regulators, the inventive research and training device may further comprise a software model that replicates the behavior of common aircraft regulators. Software development will replicate the interactions between the breathing regulator and aircrew mask under a variety of breathing scenarios within aviation relevant environments and resultant impact of regulator behaviors. The behavior of different aircraft regulators under different aviation environments and breathing scenarios will be characterized and replicated via software in the HVRD. Given sufficient information regarding regulator operation and pilot breathing demands, the HVRD can be used to simulate regulator operation without needing the actual aircraft regulator. Such capabilities will improve research to optimize both pilot health and the specifications and test conditions associated with PE sensor development.

### REFERENCES

1. Bentley, R. A., Griffin, O. G., Love, R. G., Muir, D. C., & Sweetland, K. F. (1973). Acceptable levels for breathing resistance of respiratory apparatus. Arch Environ Health, 27(4), 273-280.
2. Borg, G. (1970). Perceived Exertion as an Indicator of Somatic Stress. Scand. J. Rehabil. Med., 2(2), 92-98.
3. Caretti, D. M., & Whitley, J. A. (1998). Exercise performance during inspiratory resistance breathing under exhaustive constant load work. Ergonomics, 41(4), 501-511.
4. Cerretelli, P., Sikand, R., & Farhi, L. (1969). Effect of increased airway resistance on ventilation and gas exchange during exercise. Journal of Applied Physiology, 27(5), 597-600. doi: 10.1152/jappl.1969.27.5.597.
5. Chen, R. C., & Yan, S. (1999). Perceived inspiratory difficulty during inspiratory threshold and hyperinflationary loadings. Am. J. Respir. Crit. Care Med., 159, 720-727.
6. Damato, E., Flak, T., Mayes, R., Strohl, K., Ziganti, A., Abdollahifar, A., et al. (2020). Neurovascular and cortical responses to hyperoxia: Enhanced cognition and electroencephalographic activity despite reduced perfusion. Journal of Physiology, 598.18, 3941-3956.
7. Dean, J. (2020). The beneficial O₂ paradox: Hyperoxia-enhanced neurocognition and vigilance during reduction in global cerebral blood flow. Journal of Physiology, 598.18, 3821-3822.
8. Deno, N. S., Kamon, E., & Kiser, D. M. (1981). Physiological responses to resistance breathing during short and prolonged exercise. American Industrial Hygiene Association Journal, 42(8), 616-623.
9. Eckert, D. J., McEvoy, R. D., George, K. E., Thomson, K. J., & Catcheside, P. G. (2008). Effects of hypoxia on genioglossus and scalene reflex responses to brief pulses of negative upper-airway pressure during wakefulness and sleep in healthy men. J. Appl. Physiol., 104, 1426-1435.
10. Gordge, D. (1993). In-flight measurement of aircrew breathing in Navy aircraft. Technical Memorandum #TM 93-59 SY, N62269/93/VX/0006. Naval Air Warfare Center Aircraft Division, Patuxent River, MD
11. Gordge, D. (2004). CRU103A/P oxygen regulator flow performance. Laboratory Report No. 4632-2004-02, Gas and Fluid Flow Laboratory, Naval Air Warfare Center, Patuxent River, MD
12. R Core Team (2020). R: A language environment for statistical computing. R Foundation for Statistical Computing, Vienna, Austria. URL https://www.R-project.org/.
13. Robinson, E., Warkander, D., & Shykoff, B. (2020). The effect of reduced breathing gas delivery pressure on respiration, physiology, performance, and subjective symptomology in the T-45 aircraft. Technical report no. NAMRU-D-21-012. Naval Medical Research Unit Dayton, Wright-Patterson Air Force Base, Dayton, OH.
14. Robinson, E., Shykoff, B., & Warkander, D. (2022). Components of aircraft life support systems interact with each other and the user. Frontiers in Physiology, 13. Doi https://doi.org/10.3389/fphys.2022.969167.
15. Romaniuk, J. R., Supinski, G. S., & DiMarco, A. F. (1993). Reflex control of diaphragm activation by thoracic afferents. J. Appl. Physiol., 75(1), 63-69.
16. Shykoff, B., Blacker, K., & Lee, L. (2021). Effects of fluctuations in oxygen partial pressure from normoxia to moderate hyperoxia. Technical report NAMRU-D-21-156. AD1155417.pdf (dtic.mil)
17. Shykoff, B., & DiPasquale, D. (2018). Physiologic effects of fluctuations in oxygen partial pressure: A literature review. Technical report NAMRU-D-19-32. 19-32-TR Lit review Shykoff DTIC_01302019.pdf
18. Shykoff, B., Lee, L., Warkander, D., Robinson, E., Gallo, M., & Griswold, C. (2020). Comparison of transcutaneous and end-tidal CO₂ measurements in aerospace environments. Technical report NAMRU-D-21-002. AD1112026.pdf (dtic.mil)
19. Shykoff, B. E., & Warkander, D. E. (2011). Physiologically acceptable resistance of an air purifying respirator. Ergonomics, 54(12), 1186-1196.
20. Shykoff, B. E., & Warkander, D. E. (2012). Exercise carbon dioxide (CO₂) retention with inhaled CO₂ and breathing resistance. UHM, 39 (4), 815-828.
21. Wobbrock, J. O., Findlater, L., Gergle, D., and Higgins, J. J. (2011). The Aligned Rank Transform for Nonparametric Factorial Analyses Using Only ANOVA Procedures. Proceedings of the ACM Conference on Human Factors in Computing Systems (CHI 2011). Vancouver, British Columbia (May 7-12, 2011). New York: ACM Press, pp. 143-146. https://depts.washington.edu/acelab/proj/art/. DOI: 10.1145/1978942.1978963
22. Yan, S., & Bates, J. H. T. (1999). Breathing responses to small inspiratory threshold loads in humans. J. Appl. Physiol., 86(3), 874-880.
23. Zin, W. A., Rossi, A., & Milic-Emili, J. (1983). Model analysis of respiratory responses to inspiratory resistive loads. J. Appl. Physiol.: Respirat Environ. Exercise Physiol., 55(5), 1565-1573.

1) A research and training device, comprising:
(a) two or more gas sources, each containing a different content gas, wherein flow rate at an outlet of each of two or more gas sources is controlled by a flow controller;
(b) a mixing chamber is in fluid communication with said two or more gas sources and an inspired gas reservoir, wherein said two or more content gases are mixed in said mixing chamber forming a breathing gas and delivered to said inspired gas reservoir;
(c) a breathing hose is in fluid communication with said inspired gas reservoir and a breathing mask, wherein said breathing gas is delivered from said inspired gas reservoir to said breathing hose and the breathing mask;
(d) one or more sensors are placed between said inspired gas reservoir and said breathing hose; and
(d) a main controller operationally connected to said one or more sensors and said flow controllers, wherein said main controller contains preprogramed breathing gas profile for each of a selection of flight scenarios and is adapted to
(i) to receive and record measurements from said one or more sensors; and
(ii) to control flow rate of each gas source outlet by said individual flow controllers.

2) The research and training device of claim 1, wherein at least one said content gas is oxygen.

3) The research and training device of claim 2, wherein said content gas source comprises carbon dioxide, argon, nitrogen or air.

4) The research and training device of claim 1, wherein said one or more sensors is a flow meter, a pressure sensor or a gas analyzer.

5) The research and training device of claim 4, wherein said flow meter measures flow rate up to 350 liters per minute (LPM).

6) The research and training device of claim 4, wherein said pressure sensor has a measuring range between 0-100 pounds per square inch gauge (PSIG)

7) The research and training device of claim 4, wherein said gas analyzer is capable of measuring concentration of oxygen, nitrogen, carbon dioxide and argon gas.

8) The research and training device of claim 1, wherein said inspired air reservoir is a pressure vessel or air bag.

9) The research and training device of claim 1, further comprises a pressure controller or a back pressure controller located between said one or more sensor and breathing hose and is operationally connected to said main controller.

10) The research and training device of claim 9, wherein said main controller
a) received measurements from said one or more sensors;
b) adjust flow rate at each of two or more gas sources using said flow controllers; and
c) adjust the pressures of said breathing gas inside the inspire air reservoir or breathing hose using said back pressure controller or pressure regulator.

11) The research and training device of claim 9, wherein said main controller makes said pressure and flow rate adjustment based on measurements from said one or more sensors and a selected breathing gas profile.

12) The research and training device of claim 11, where said breathing gas profile is based on real flight measurements of a flight scenario.

13) The research and training device of claim 1 or claim 9, further comprising manual controls operationally connected with said main controller.

14) A method for simulating fluctuating breathing gas supply to a subject during flight, comprising
a) providing a research and training device of claim 9;
b) selecting a flight scenario;
c) setting a profile for an inspired breathing gas mixture to be supplied to said subject during said simulation based on selected flight scenario, wherein said profile comprises
i) content gases of said inspired breathing gas mixture;
ii) concentration of each said content gas;
iii) flow rate of each said content gas; and
iv) pressure of said inspired breathing gas mixture; and
d) executing said simulation according to said profile.

15) The method of claim 14, further comprises step
(e) recording breathing responses of said subject during said simulation.

16) The method of claim 15, wherein said breathing responses include measurements taken under the subject's breathing mask, comprising
a) pressure;
b) content gas concentrations; and
c) flow rate.

17) The method of claim 15, wherein said breathing response includes MRI images of the subject during said simulation.

18) A method for training a user during a flight ventilation simulation, comprising:
a) providing a research and training device of claim 9;
b) establishing a flight scenario for said simulation;
c) setting a profile for an inspired breathing gas mixture to be supplied to said user during said simulation based on selected flight scenario, wherein said profile comprises
i) content gases of said inspired breathing gas mixture;
ii) concentration of each of said content gas;
iii) flow rate of each said content gas; and
iv) pressure of said inspired breathing gas mixture;
d) executing said simulation according to said profile;
e) measuring breathing responses of said subject during said simulation;
e) provide training to said user based on user's breathing responses measurements during said simulation.

19) The method of claim 18, wherein said user is trained on recognition and response to hypoxia, hyperoxia, hypercapnia, or fluctuation in oxygen supply.
